(19) United States
(12) Patent Application Publication
(10) Pub. No.: US 2024/0109489 A1
(43) Pub. Date: Apr. 4, 2024

(54) METHOD FOR OPERATING A LIGHTING ASSISTANCE SYSTEM

(71) Applicant: MERCEDES-BENZ GROUP AG, Stuttgart (DE)

(72) Inventor: Klaus Alfred HERMANN, Gärtringen (DE)

(21) Appl. No.: 18/267,834

(22) PCT Filed: Oct. 15, 2021
(86) PCT No.: PCT/EP2021/078574

§ 371 Date: Jun. 16, 2023

(30) Foreign Application Priority Data
Dec. 18, 2020 (DE) 10 2020 007 759.5

(51) Int. Cl. B60Q 11/00; B60Q 1/14

(52) U.S. Cl. CPC B60Q 11/005; B60Q 1/143; B60Q 2300/112; B60Q 2300/146; B60Q 2300/3321; B60Q 2300/41; B60Q 2300/42

(57) ABSTRACT

A method for operating a lighting assistance system for a vehicle equipped with a camera at least for recording oncoming traffic participants or traffic participants driving ahead and with a device for recognizing an urban environment is provided. When driving in the urban environment, a full beam is prevented from being switched on. When driving in the urban environment, error messages relating to the limited view of the camera are suppressed.

### BACKGROUND AND SUMMARY OF THE INVENTION

Exemplary embodiments of the invention relate to a method for operating a lighting assistance system for a vehicle.

Lighting assistance systems for vehicles are known from the prior art. They are also sometimes described by the English term Intelligent Headlight Control (IHC). Fundamentally, they always consist of a camera typically aligned forwards in the direction of travel, via which oncoming traffic participants and traffic participants driving ahead are recognized and removed from the light distribution of the high beam of the own vehicle. This can be achieved, for example, by simply fading from a high beam to a so-called low beam, or, in more complex lighting systems, by targetedly reducing the glare of these traffic participants by generating a “gap” in the high beam distribution in the region, as the e.g., oncoming traffic participant should not be dazzled.

It is further the case that such lighting assistance systems are typically operated such that the high beam assistant is only used on A-roads, motorways, and the like, while it remains switched off in an urban environment, and thus for example in city traffic, when driving through villages, settlements, industrial areas or the like. For example, in this context, reference can be made to DE 10 2009 028 342 A1, which describes a method and a device for activating the city light of a vehicle depending on the environment recognized. In the context of the sense described above, this city light is the forgoing of an activation of the high beam in the lighting assistant. In the case of the specified document, street lighting units are recorded in order to recognize the urban environment, and it is determined whether or not the vehicle is in an urban environment using the spatial distance of these street lighting units from one another. Other methods for determining an urban environment, for example using the environment's lighting level or using satellite navigation coordinates of the vehicle and a comparison with a corresponding map are also known from the further prior art.

In practice, it can occur that, while environment sensors of a vehicle function per se, they are blocked by dirt, for example. They can then no longer be used for the provided purposes. In this context, reference can be made purely as an example to DE 10 2018 220 114 A1, or to DE 10 2018 220 113 A1, which substantially corresponds to the former. These documents describe as further general prior art that such blockages can be recognized as such using movement patterns of the vehicle.

In practice and with reference to a lighting assistance system, such an outage of a sensor can, for example, be a limited view of the camera, in particular due to dirt, strong precipitation, an impact on a windowpane through which the camera is looking, or the like. In practice, this leads to an error message being generated, which shows a person driving the vehicle that the lighting assistance system is temporarily non-functional, so that this person is correspondingly informed of the temporary lack of accessibility of their assistance system.

Exemplary embodiments of the present invention are directed to an improved method for operating a lighting assistance system, which reduces an unnecessary display of error messages.

In the method according to the invention, it is the case that, according to the invention, when driving in an urban environment, potentially occurring error messages relating to the limited view of the camera are suppressed. As already explained above, in such lighting assistance systems, it is mostly necessary to recognize urban environments one way or another in any case. The lighting assistance system thus knows that it is in an urban environment and that the high beam for which the assistance system is responsible with regard to brightening and/or dimming, and optionally reducing the glare of oncoming traffic participants or, in addition, traffic participants driving ahead, is not necessary. In the urban environment, the low beam is generally consistently used when driving.

It is, in particular, the case, however, that many people who use their vehicle start usage in an urban environment. In the autumn and winter months in particular, it is more frequently the case that in the event of correspondingly low temperatures and when the vehicle is stationary, the inside of the windscreen fogs up relatively quickly, as moisture from the vehicle settles on the typically colder window pane. Many cameras, used for, among other things, the lighting assistance system and optionally also for other uses, are installed in the top front region of the windscreen and aligned forwards in the direction of travel. If the windscreen is fogged up, then the view of this camera is limited. The same applies to a top region of a windscreen that may still be covered with ice or icy/snowy residue that has not been carefully removed from the top region of the windscreen through which a person driving the vehicle does not usually look before the drive begins. It is precisely this that causes the lighting assistance system to first be activated if the journey begins in an urban environment in darkness and then to recognize that the view of the camera it is using is blocked or limited. This is of no importance for the urban environment in practice, as in the urban environment the low beam is used when driving in any case, and the assistance system is never used to the intended extent to brighten and dim the high beam here.

By the method according to the invention, precisely this error message in relation to the limited camera view, which has no effect on the practical usage of the vehicle, is now correspondingly suppressed in such a situation. The person driving the vehicle is thus spared unnecessary warnings and can thus concentrate better on the traffic events than if a corresponding warning to the effect “high beam assistant deactivated due to blocked camera view” were to be shown in the instrument cluster. By the method according to the invention, such an error message that the camera has a limited view when situations are being recorded in which a high beam is not required in any case are thus suppressed.

A further very favorable embodiment of the method according to the invention further provides that when leaving the urban environment and an error message relating to the limited view of the camera continues to be present, this error message is displayed after a pre-determined period of time since leaving the urban environment.

This advantageous development of the method according to the invention ensures that when leaving the urban environment, the error message is shown if still current, and thus, for example, if the windowpane is still correspondingly fogged up, in order to correspondingly inform the person driving the vehicle in this situation in which the high beam represents a useful support. The error message is preferably not shown until a pre-determined period of time has elapsed in order, on the one hand, not to “startle” the person driving the vehicle with the error message immediately on the border of the urban area and, on the other hand, to ensure during a journey on the outskirts of the urban area that the error message is not displayed unnecessarily if the vehicle drives back into the urban area within a very short period of time.

A further very favorable embodiment of this idea provides that a person using the vehicle can actively change the pre-determined period of time. The suppression of the warning after leaving the urban area can thus be influenced by a person using the vehicle with regard to the period of time, for example by the person independently configuring a preferred period of time via a menu system or the like to adjust the vehicle and the potential display or suppression of such error messages to their individual needs.

As already mentioned, the method can, in particular, be useful if a camera arranged behind the windscreen with a view through the windscreen in the direction of travel is used for the lighting assistance system. However, the method can also be used for other cameras, for example external cameras, the views of which can be impaired by snow or ice or a large amount of condensation.

The device for recognizing the urban environment can, in particular, use street lighting recognized by environment sensors, a brightness recorded by a sensor, a driving speed and a position of the vehicle determined via satellite navigation in comparison with a map showing the urban environment to determine whether the vehicle is in an urban environment. In particular, these possibilities can also be combined with one another so that the urban environment can be recognized as reliably as possible.

According to an exceptionally favorable embodiment thereof, it can be provided that the urban environment is determined using street lighting, specifically by counting the number of recognized street lamps and then inferring an urban environment based on a pre-determined number of street lamps, in particular a pre-determined number of street lamps per unit of distance.

In this method, street lamps are thus counted and evaluated as a total number or as a number per distance unit. Upwards of a particular number, it is then assumed that an urban environment is present. Additionally, this can, for example, be combined via a brightness sensor to nevertheless recognize an urban environment or daylight in the case of particular brightness values, and to operate the lighting assistance system as such in the mode for the urban environment or to correspondingly deactivate said lighting assistance system during the day. As a further development, the position of the vehicle can additionally be determined, in particular to validate the results recognized via the sensor system of the vehicle.

Further advantageous embodiments of the method according to the invention result from the exemplary embodiment, which is described in more detail in the following with reference to the figures.

### BRIEF DESCRIPTION OF THE DRAWING FIGURES

In the figures:

FIG. 1 shows a schematic depiction of a vehicle having a camera in an urban environment recognized by the camera; and

FIG. 2 shows a process diagram of a possible embodiment of the method according to the invention.

### DETAILED DESCRIPTION

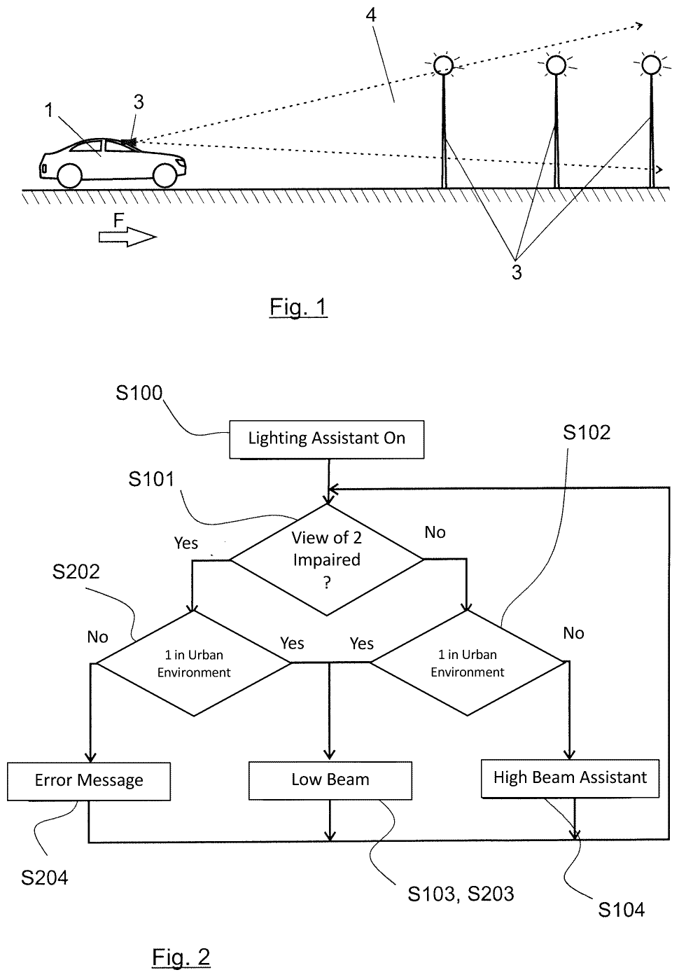

In the depiction of FIG. 1, a vehicle described by 1 can be seen that should be equipped with an indicated multi-functional camera 2. This multi-functional camera on the one hand serves to record the environment of the vehicle 1, and on the other hand can be used for a so-called lighting assistance system.

In the scenario depicted in FIG. 1, three street lamps each labelled with 3 on the edge of a road being driven down by the vehicle are schematically shown. The street lamps are in the camera's field of vision labelled with 4, and are correspondingly recognized by the multi-functional camera in a computer unit inside the multi-functional camera or optionally also outside of this multi-functional camera 2. Upwards of a certain number, the conclusion is drawn that the vehicle is in an urban environment.

These or other possibilities for recognizing an urban environment can be used for a lighting assistance system in a manner known per se. In the urban environment, the lighting assistance systems is then limited to the so-called low beam, and if no urban environment is present, the high beam is also correspondingly used and brightened or dimmed as needed by the lighting assistance system, or the glare of traffic participants driving ahead or oncoming traffic participants is actively reduced if, for example, pixel headlights or headlights having other suitable methods of influencing the light distribution are used that enable targeted glare reduction for individual traffic participants to be de-illuminated in a targeted manner.

In the depiction of FIG. 2, which shows a principle process sequence, this part of the lighting assistance system known per se is substantially depicted in the bottom right region. This is explained in detail in the following.

Unlike what is shown in the schematic depiction of FIG. 1, the multi-functional camera 2 is typically arranged behind the windscreen of the vehicle 1 and faces forwards in the direction of travel F. If the windscreen is fogged up, or not entirely freed from ice and snow in the top region in which the multi-functional camera 2 is looking through the windscreen, then this can be damaging to the view of the multi-functional camera 2. If this is the case, then an error message is generated in the systems according to the prior art, the error message only irritating the person driving the vehicle 1 unnecessarily and distracting them from traffic events in some circumstances.

The method proposed thus provides that after the lighting assistance system is switched on in the first step described by S100, in the step S101 it is queried whether the view of the multi-functional camera 2 is impaired. If this is not the case, then the conventional operation of the lighting assistance system is used. For this purpose, as already mentioned above, it is necessary to recognize whether the vehicle 1 is in an urban environment. This is achieved via the query in step S102. If the vehicle is in an urban environment, then in step S103 the operation is exclusively performed with the low beam and the method returns to the beginning and repeatedly runs through the corresponding steps. If the urban area is left or if the start of the lighting assistance system is outside of the urban area, then instead of step S103, step S104 will occur, in which the high beam is activated and the lighting assistance system is thus actively in use as a high beam assistant. The steps S102-S104 are, as already mentioned above, in principle the part performed as in a conventional lighting assistance system, wherein the query S102 is necessary in all instances to determine whether the operation should be performed with the low beam according to step S103 or with the high beam according to step S104.

The method according to the invention is used when the view is correspondingly impaired. Typically, this would lead to an error message independently of the otherwise present use of the lighting assistance system. According to the invention, in this branch, in which the query in S101 is answered with yes, the query of whether the vehicle 1 is in an urban environment is carried out. This step is described with S202 here and uses the data basis present anyway for step S102. If this is not the case, and the vehicle is thus located outside of an urban environment, then in step S204 the error message known per se is generated, for example that the high beam assistant is unavailable due to an impaired view of the camera 2, and for example transmitted on a multi-functional display of the vehicle 1 for a person driving the vehicle 1. Often, however, the vehicle 1 is in an urban environment because vehicles 1 have a high probability of beginning their journey in an urban environment and the problem of fogged-up windowpanes typically occurs at the beginning of the journey. In this case, after the query in step S202, the method skips directly to the step S203, and thus the sensible operation for the urban environment with the low beam is initiated. The error message is not required or the error message is actively suppressed in the method according to the invention. The person driving the vehicle 1 is thus not burdened with error messages unnecessary in this situation, and potentially distracted from traffic events.

Similar to step S204, the method also jumps back here to before the query in step S101, so that it is possible to react in one of the steps S102 or S202 appropriately to the changing situation, both with regard to the impaired view of the camera in step S101 and for example to leaving the urban area.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-6. (canceled)

7. A method for operating a lighting assistance system for a vehicle equipped with a camera that at least records oncoming traffic participants or traffic participants driving ahead, the method comprising:
recognizing that the vehicle is in an urban environment, wherein, responsive to recognizing that the vehicle is in an urban environment a full beam of the vehicle is prevented from being switched on, and wherein when driving in the urban environment, error messages relating to a limited view of the camera are suppressed.

8. The method of claim 7, further comprising:
recognizing that the vehicle leaves the urban environment, wherein responsive to recognizing that the vehicle leaves the urban environment and when an error message relating to the limited view of the camera continues to be present, the error message is displayed a pre-determined period of time after leaving the urban environment.

9. The method of claim 8, wherein the predetermined period of time is user-configurable.

10. The method of claim 7, wherein the camera arranged behind a windscreen of the vehicle with a view through the windscreen in a direction of travel.

11. The method of claim 7, wherein the recognition that the vehicle is in the urban environment comprises evaluating at least street lighting, a brightness, a vehicle speed, or a position of the vehicle recorded via a satellite navigate system in relation to a map of the urban environment.

12. The method of claim 11, wherein the urban environment is recognized using the street lighting by counting a number of recognized street lamps and a distance unit inferring an urban environment upwards of a pre-determined absolute number of street lamps or a pre-determined number of street lamps.
